(19) United States
(12) Patent Application Publication
(10) Pub. No.: US 2010/0147258 A1
(43) Pub. Date: Jun. 17, 2010

(54) Engine control system having gradual cylinder cutout

(75) Inventors: Michael W. Edwards, West Lafayette, IN (US); James W. Harris, Galveston, IN (US); Matthew J. Miller, Lafayette, IN (US); Chad G. Beasey, Monon, IN (US); Brian E. Layton, Wolcott, IN (US); Gregory L. Armstrong, Edwards, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 12/314,848

(22) Filed: Dec. 17, 2008

(51) Int. Cl. F02D 17/02

(52) U.S. Cl. 123/198 F; 123/446; 701/112

(57) ABSTRACT

A control system for an engine having a plurality of combustion chambers is disclosed. The control system may have a plurality of fuel injectors associated with the plurality of combustion chambers, and a controller in communication with each of the plurality of fuel injectors. The controller may be configured to determine a need to inhibit fueling of a subset of the plurality of combustion chambers. The controller may also be configured to selectively regulate the plurality of fuel injectors to inhibit fueling of a fraction of the subset at a time until fueling of all of the subset has been inhibited.

### TECHNICAL FIELD

This application relates generally to an engine control system, and more particularly to an engine control system having gradual cylinder cutout.

### BACKGROUND

Cylinder cutout is a method of reducing or completely stopping combustion within one or more cylinders of an engine. Cylinder cutout is used during light loading conditions to improve efficiency of the engine, or during cold conditions to raise the temperature of the operating cylinders and subsequently the rest of the engine.

An exemplary system implementing cylinder cutout is described in U.S. Pat. No. 5,826,563 (the '563 patent), issued to Patel et al. on Oct. 27, 1998. Specifically, the '563 patent discloses a high-horsepower diesel engine for use with an electrical power generator in a locomotive application. When the engine is operating in a low-horsepower mode, for example when idling, the engine enters a skip-firing control. During the skip-firing control, a number of the engine's cylinders are not fueled during a single rotation of the engine's shaft, such that the remaining cylinders receiving fuel are required to operate at an increased power output. In particular, when the low-horsepower mode is detected, a control unit determines how many of the engine's cylinders can be skipped (not fueled) in any engine shaft rotation without causing the engine to speed bog or produce excessive exhaust emissions. Within such limits, the control unit computes a minimum number of cylinders that can be fired and still produce the required horsepower to maintain locomotive functions. Given the number of cylinders to be fired in any shaft revolution, the control unit selects and implements a pattern of cylinder firings that will fire the desired number of cylinders per revolution and will fire all cylinders in successive revolutions.

Although the system of the '536 patent may be suitable for a locomotive application, it may have limited applicability in stationary power generation where consistent characteristics of the produced electrical power are critical. Specifically, the manner in which cylinders are fueled and not fueled (i.e., skipped) can greatly affect an output of the engine and corresponding characteristics of the electrical power output produced by the associated generator. And, the '536 patent does not provide a method for implementing the skipping such that electrical power output remains as desired during the skipping.

The presently disclosed engine control system is directed to overcoming one or more of the problems set forth above and/or other problems of the prior art.

### SUMMARY

In one aspect, the present disclosure may be directed to a control system for an engine having a plurality of combustion chambers. The control system may include a plurality of fuel injectors associated with the plurality of combustion chambers, and a controller in communication with each of the plurality of fuel injectors. The controller may be configured to determine a need to inhibit fueling of a subset of the plurality of combustion chambers. The controller may also be configured to selectively regulate the plurality of fuel injectors to inhibit fueling of a fraction of the subset at a time until fueling of all of the subset has been inhibited.

In another aspect, the present disclosure may be directed to a method of operating an engine. The method may include injecting fuel into a plurality of combustion chambers, and determining a need to inhibit fueling of a subset of the plurality of combustion chambers. The method may also include selectively inhibiting fueling of a fraction of the subset at a time until fueling of all of the subset has been inhibited.

### BRIEF DESCRIPTION OF THE DRAWINGS

FIG. 1 is a schematic and diagrammatic of an exemplary disclosed generator set; and

FIG. 2 is a flow chart illustrating an exemplary disclosed method of operating the generator set of FIG. 1.

### DETAILED DESCRIPTION

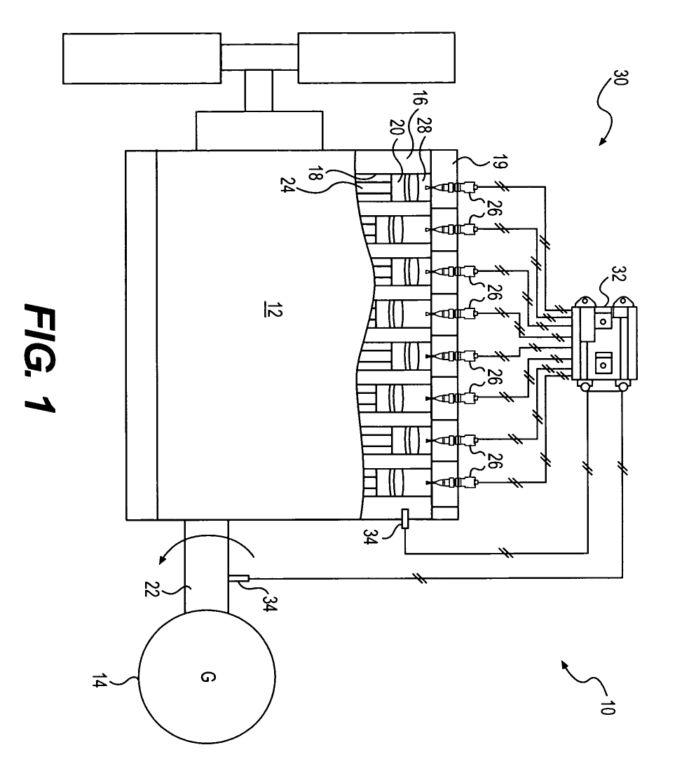

FIG. 1 illustrates a generator set (genset) 10 having a prime mover 12 coupled to mechanically rotate a generator 14 that provides electrical power to an external load (not shown). For the purposes of this disclosure, prime mover 12 is depicted and described as a heat engine, for example an internal combustion engine that combusts a mixture of fuel and air to produce the mechanical rotation. One skilled in the art will recognize that prime mover 12 may be any type of combustion engine such as, for example, a diesel engine, a gasoline engine, or a gaseous fuel-powered engine. Generator 14 may be, for example, an AC induction generator, a permanent-magnet generator, an AC synchronous generator, or a switched-reluctance generator. In one embodiment, generator 14 may include multiple pairings of poles (not shown), each pairing having three phases arranged on a circumference of a stator (not shown) to produce an alternating current with a frequency of about 50 and/or 60 Hz. Electrical power produced by generator 14 may be directed for offboard purposes to the external load.

Prime mover 12 may include an engine block 16 at least partially defining a plurality of cylinders 18, and one or more cylinder heads 19 connected to engine block 16 to form a plurality of combustion chambers 28. In one example, engine block 16 may include sixteen combustion chambers 28 (only eight shown). However, it is contemplated that engine block 16 may include a greater or lesser number of combustion chambers 28 and that combustion chambers 28 may be disposed in an “in-line” configuration, a “V” configuration, or in any other suitable configuration.

A piston 20 may be slidably disposed within each of combustion chambers 28, so as to reciprocate between a top-dead-center (TDC) position and a bottom-dead-center (BDC) position during an intake stroke, a compression stroke, a combustion or power stroke, and an exhaust stroke. Pistons 20 may be operatively connected to a crankshaft 22 via a plurality of connecting rods 24. Crankshaft 22 may be rotatably disposed within engine block 16 and operatively connected to generator 14 such that a reciprocating motion of each piston 20 results in a corresponding rotation of connected generator 14.

Pistons 20 may move through the intake stroke from the TDC position to the BDC position to draw air into the respective combustion chambers 28. Piston 20 may then return to the TDC position, thereby compressing the air during the compression stroke. Toward an end of the compression stroke and/or during a first portion of the power stroke, a fuel injector 26 associated with each combustion chambers 28 may deliver pressurized injections of fuel into combustion chambers 28 and, in some situations, the pressurized injections may mix with the pressurized air and initiate combustion. When ignited, the air-fuel mixture may cause piston 20 to move back to the BDC position during the power stroke, this downward movement of piston 20 powering the rotational movement of crankshaft 22 and generator 14. Piston 20 may then return to the TDC position to push exhaust gas from combustion chambers 28 during the exhaust stroke.

Fuel injectors 26 may be disposed within cylinder heads 19 and connected to inject fuel into combustion chambers 28. Fuel injectors 26 may embody, for example, electronically actuated—electronically controlled unit injectors, mechanically actuated—electronically controlled injectors, digitally controlled fuel valves, or any other type of fuel injectors known in the art. Each fuel injector 26 may be separately and independently operable to inject an amount of pressurized fuel into an associated combustion chamber 28 at predetermined timings, fuel pressures, and fuel flow rates.

Operation of genset 10 may be affected by the number of fuel injectors 26 actively injecting fuel into combustion chambers 28. That is, a total output (torque and/or speed) of prime mover 12 may be the result of individual combustion events within each cylinder 18. Thus, when all of combustion chambers 28 are fully operational (i.e. when all of fuel injectors 26 are actively fueling an associated combustion chamber 28), the total output of prime mover 12 may be substantially equally contributed to by each combustion chamber 28. And, likewise, when fewer than all of fuel injectors 26 are actively injecting fuel (i.e., when some fuel injectors 26 are inhibited from fueling to disable some combustion chambers 28), the total output of prime mover 12 may be contributed to by only those operational combustion chambers 28 whose associated injectors 26 are active. In this latter situation, the amount of the total output contributed to by any one combustion chamber 28 may be greater than the total output contributed by any one combustion chamber 28 in the former situation. Correspondingly, the amount of fuel injected during in the latter situation into any one combustion chamber 28 may be greater than the amount of fuel injected during the former situation such that the same total output is achieved.

In some situations, it may be desirable to have fewer than all of combustion chambers 28 operational. These situations may correspond with, for example, low engine speeds, low engine loads, and/or cold operation. Specifically, during low engine speed and/or low load situations, the amount of fuel injected by any one fuel injector 26 may be relatively small. In general, when the amount of injected fuel falls below a threshold value, because of parasitic losses of prime mover 12, an efficiency of prime mover 12 may be reduced. During this situation, it may be better to have fewer than all of combustion chambers 28 operational such that the total amount of injected fuel is spread between fewer injectors 26 (i.e., such that each fuel injector 26 injects a greater and more efficient amount of fuel). Similarly, during cold operation, the amount of fuel injected by any one fuel injector 26 and combusted within prime mover 12 may be too little to sufficiently warm prime mover 12. In this situation, it may again be better to have fewer than all of combustion chambers 28 operational such that each active fuel injector 26 may inject a greater amount of fuel and thereby warm the respective cylinder 18 by a greater degree during combustion of the injected fuel. Thus, in some situations, a subset of combustion chambers 28 may be inhibited from operation (i.e., a subset of fuel injectors 26 may be inhibited from injecting fuel).

In order to help regulate operation of fuel injectors 26 and the selective disabling of combustion chambers 28 described above, a control system 30 may be associated with genset 10. Control system 30 may include a controller 32 in communication with fuel injectors 26, and one or more sensors 34 configured to provide input to controller 32. In response to the input from sensors 34, controller 32 may determine a need to inhibit operation of one or more combustion chambers 28 and responsively adjust operation of fuel injectors 26 to accommodate particular operating conditions of prime mover 12. In this manner, operation of prime mover 12 may remain within a desired operating range.

Controller 32 may embody a single or multiple microprocessors, field programmable gate arrays (FPGAs), digital signal processors (DSPs), etc. that include a means for controlling an operation of genset 10 in response to various inputs. Numerous commercially available microprocessors can be configured to perform the functions of controller 32. It should be appreciated that controller 32 could readily embody a microprocessor separate from that controlling other genset functions, or that controller 32 could be integral with a general genset microprocessor and be capable of controlling numerous genset functions and modes of operation. If separate from the general genset microprocessor, controller 32 may communicate with the general genset microprocessor via datalinks or other methods. Various other known circuits may be associated with controller 32, including power supply circuitry, signal-conditioning circuitry, actuator driver circuitry (e.g., circuitry powering solenoids, motors, or piezo actuators), communication circuitry, and other appropriate circuitry.

Controller 32 may be configured to determine a number of combustion chambers 28 to disable (i.e., a number of fuel injectors 26 to inhibit from fueling of an associated combustion chamber 28) such that the performance of prime mover 12 substantially remains within or returns to the desired operating range. In one example, controller 32 may, based on a signal from sensor 34 and/or based on other input, reference one or more relationship maps stored in memory. Each of these maps may include a collection of data in the form of tables, graphs, and/or equations. One such relationship map may, for example, relate a desired output (i.e., torque and/or speed) of prime mover 12 or a desired output (i.e., frequency and/or voltage) of generator 14 to an amount of fuel that must be injected into and combusted within prime mover 12. The same or a different relationship map may then relate that amount fuel and information from sensor 34 to a number of fuel injectors 26 that should be operational to inject the amount of fuel and still maintain a desired efficiency and/or a desired temperature of prime mover 12, and a corresponding remaining number of combustion chambers 28 (i.e., a subset of combustion chambers 28) that should be disabled. When disabling combustion chambers 28 (i.e., when inhibiting particular fuel injectors 26 from injecting fuel), the amount of fuel injected into any one combustion chamber 28 remaining operational must increase to maintain the same mechanical output. Controller 32 may be configured to determine and implement the increased fueling at the same time as and in an amount proportional the disabling of combustion chambers 28.

In one embodiment, the subset of combustion chambers 28 may vary between disabling events. For example, in a sixteen cylinder engine, it may be fairly common to selectively disable four or even eight of the sixteen combustion chambers 28. Between disabling events (i.e., between different times of combustion chamber disabling), controller 32 may select different combustion chambers 28 to be included within the subset of combustion chambers 28 that are disabled. In this manner, no one combustion chamber 28 may either be operational or non-operational significantly more than any other combustion chamber 28.

Because characteristics (e.g., the frequency, phase, and/or voltage) of the electrical power produced by generator 14 may be sensitive to operation of prime mover 12, the disabling of combustion chambers 28 should be implemented in a relatively gradual manner. That is, to help maintain a substantially constant electrical output of generator 14, a substantially constant mechanical input from prime mover 12 must also be maintained. To help maintain the substantially constant mechanical input from prime mover 12 (i.e., to help reduce speed and/or torque fluctuations of prime mover 12), the number of combustion chambers 28 disabled at a time may be limited. That is, only a fraction of the subset of combustion chambers 28 may be disabled at a time to give prime mover 12 sufficient time to recover from the disabling such that prime mover output substantially achieves steady state between disablings. In one embodiment, the number of combustion chambers 28 disabled at any one time may be limited to one, with a time delay of about one second between combustion chamber disablings.

However, once a first subset of combustion chambers 28 has been disabled, a second subset may be disabled in a much quicker manner. In one embodiment, all combustion chambers 28 of the second subset may be disabled as a group, at about the same time the first subset of combustion chambers is re-enabled. For example, in a sixteen cylinder engine, where four combustion chambers 28 have been disabled, another subset of four combustion chambers 28 may be disabled all at once, at substantially the same time the first subset of four combustion chambers 28 is re-enabled. In most situations, the number of combustion chambers 28 in each subset may be about equal.

When adjusting the operation of fuel injectors 26 to disable the subset of combustion chambers 28, controller 32 may generate and send fuel delivery altering signals to fuel injectors 26. These signals may function to adjust a fuel delivery rate, a fuel delivery timing, a fuel delivery pressure, and/or a fuel torque limit. These fuel delivery altering signals may be produced in accordance with prime mover control maps such as, for example, rail pressure maps, timing maps, torque limit maps, etc., as are known in the art. The fuel delivery altering signals may be delivered to those fuel injector 26 associated with the subset of combustion chambers 28.

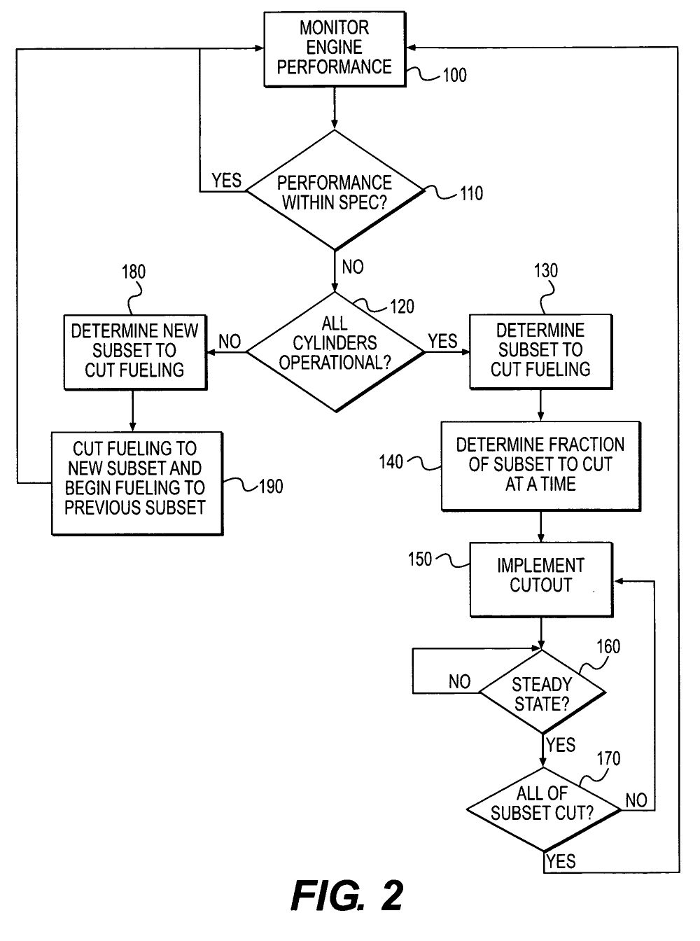

FIG. 2 illustrate an exemplary operation performed by control system 30 FIG. 2 will be discussed in more detail in the following section to further illustrate the disclosed concepts.

### INDUSTRIAL APPLICABILITY

Although particularly applicable to prime movers associated with electrical power generation, the disclosed engine control system may be applicable to any diesel, gasoline, or gaseous-fuel powered engine known in the art. The disclosed engine control system may implement gradual cylinder cutout based on monitored engine operation such that the mechanical power output of the engine may be consistently maintained. The operation of control system 30 will now be explained.

As illustrated in FIG. 2, operation of control system 30 may initiate at startup of genset 10 by monitoring performance of prime mover 12 via sensor 34 (Step 100). As described above, the performance may include, among other things, a temperature, a speed, and/or a load. Controller 32 may receive input from sensor 34, and compare the input to an expected performance range to determine if operation of prime mover 12 is within specification (Step 110).

If performance of prime mover 12 is within the expected performance range, control may return to step 100. However, if performance of prime mover 12 has deviated from is anticipated to deviate from the expected performance range, controller 32 may determine if any of combustion chambers 28 are already disabled (Step 120). If no combustion chambers 28 are already disabled, controller 32 may then determine a number of combustion chambers 28 (i.e., a subset of combustion chambers 28) that should be disabled to bring performance back to within the expected performance range (Step 130). As described above, controller 32 may make this determination based on the values of the signals from sensor 34 and on ratings of prime mover 12, with reference to one or more relationship maps.

Controller 32 may then determine how many of the subset of combustion chambers 28 (i.e., what fraction of the subset) should be disabled at a time (Step 140). As also described above, the number of combustion chambers 28 disabled at a time should be limited such that the mechanical output of prime mover 12 and the resulting electrical output of generator 14 remains substantially consistent. In some situations, this fraction may consist of a single combustion chamber 28. Controller 32 may then disable the fraction of the subset of combustion chambers 28, and delay a time between disablings (Step 150). In some applications, the time may be about one second. However, it is contemplated that controller 32 may monitor performance of prime mover 12 to determine if steady state operation thereof has been achieved, before implementing a subsequent disabling (Step 160), regardless of time, if desired.

Once the time delay has expired and/or steady state operation has been observed, controller 32 may determine if all of the combustion chambers 28 included within the subset have been appropriately disabled (Step 170). If all of the subset of combustion chambers have been disabled, control may return to step 100. If additional combustion chambers 28 still require disabling, control may return to step 150.

Returning to step 120, in some situations, it may be possible that a subset of combustion chambers 28 has already been disabled when controller 32 determines that another subset must alternatively be disabled. When this condition exists, controller 32 may determine the new subset to disable that includes different ones of combustion chambers 28 (Step 180). Controller 32 may then simultaneously disable the new subset of combustion chambers 28 and re-enable the previously disabled subset (Step 190). At step 190, all combustion chambers 28 being enabled may be enabled at the same time, while all combustion chambers 28 being disabled may be disabled at the same time. The reason for this may be that prime mover 12 has already adapted to the first subset being disabled, and should continue to operate at steady state during and after the completion of step 190.

The disclosed engine control system may provide several advantages. In particular, because engine control system 30 may be capable of gradually implementing cylinder cutout, the mechanical output of prime mover 12 may remain substantially consistent. And, the consistent mechanical output of prime mover 12 may result in a substantially consistent electrical output of generator 14.

It will be apparent to those skilled in the art that various modifications and variations can be made to the disclosed engine control system. Other embodiments will be apparent to those skilled in the art from consideration of the specification and practice of the disclosed engine control system. It is intended that the specification and examples be considered as exemplary only, with a true scope being indicated by the following claims and their equivalents.

What is claimed is:

1. A control system for an engine having a plurality of combustion chambers, the control system comprising:
a plurality of fuel injectors associated with the plurality of combustion chambers; and
a controller in communication with each of the plurality of fuel injectors and being configured to:
determine a need to inhibit fueling of a subset of the plurality of combustion chambers; and
selectively regulate the plurality of fuel injectors to inhibit fueling of a fraction of the subset at a time until fueling of all of the subset has been inhibited.

2. The control system of claim 1, wherein the fraction consists of a single combustion chamber.

3. The control system of claim 1, wherein the controller is further configured to delay a time after inhibiting fueling of one fraction of the subset before inhibiting fueling of another fraction of the subset.

4. The control system of claim 3, wherein the time is sufficient for the remaining ones of the plurality of combustion chambers being fueled to substantially achieve steady-state operation.

5. The control system of claim 1, wherein the controller is further configured to vary which of the plurality of combustion chambers are included in the subset between inhibiting events.

6. The control system of claim 5, wherein the subset is a first subset, and the controller is further configured to:
determine a need to inhibit fueling of a second subset of the plurality of combustion chambers; and
selectively regulate the plurality of fuel injectors to inhibit fueling of all of the second subset and to substantially simultaneously begin fueling of all of the first subset,
wherein the number of combustion chambers included within the first subset is equal to the number of combustion chambers included within the second subset.

7. The control system of claim 1, wherein the controller is further configured to:
determine an amount of increased fueling for the remaining operational ones of the plurality of combustion chambers; and
regulate the plurality of fuel injectors to selectively implement the increased fueling at about the same time the fueling of the subset is selectively inhibited.

8. The control system of claim 1, further including a sensor configured to monitor engine performance and generate a signal directed to the controller indicative of the engine performance, wherein the controller is configured to determine the need to inhibit fueling based on the engine performance.

9. The control system of claim 8, wherein the engine performance is associated with an engine temperature.

10. The control system of claim 8, wherein the engine performance is associated with at least one of an engine speed and a load.

11. A method of operating an engine, comprising:
injecting fuel into a plurality of combustion chambers;
determining a need to inhibit fueling of a subset of the plurality of combustion chambers; and
selectively inhibiting fueling of a fraction of the subset at a time until fueling of all of the subset has been inhibited.

12. The method of claim 11, wherein the fraction consists of one combustion chamber.

13. The method of claim 11, further including delaying a time after inhibiting fueling of one fraction of the subset before inhibiting fueling of another fraction of the subset.

14. The method of claim 13, wherein the time is sufficient for the remaining ones of the plurality of combustion chambers being fueled to substantially achieve steady-state operation.

15. The method of claim 11, further including varying which of the plurality of combustion chambers are included in the subset between inhibiting events.

16. The method of claim 15, wherein the subset is a first subset, and the method further includes:
determining a need to inhibit fueling of a second subset of the plurality of combustion chambers; and
selectively inhibiting fueling of all of the second subset and substantially simultaneously fueling of all of the first subset,
wherein the number of combustion chambers included within the first subset is equal to the number of combustion chambers included within the second subset.

17. The method of claim 11, further including:
determining an amount of increased fueling for the remaining operational ones of the plurality of combustion chambers; and
selectively implementing the increased fueling at about the same time the fueling of the subset is selectively inhibited.

18. The method of claim 11, further including monitoring an engine performance, wherein the need to inhibit fueling is based on the engine performance.

19. The method of claim 18, wherein the engine performance is associated with at least one of an engine temperature, an engine speed, and an engine load.

20. A genset, comprising:
a generator operable to produce an electrical power output;
an engine connected to drive the generator and including:
a plurality of combustion chambers;
a plurality of fuel injectors associated with the plurality of combustion chambers;
a sensor configured to monitor a performance of the engine and generate a signal indicative of the engine performance; and
a controller in communication with each of the plurality of fuel injectors and the sensor, the controller being configured to:
determine a need to inhibit fueling of a first subset of the plurality of combustion chambers based on the signal;
selectively regulate the plurality of fuel injectors to inhibit fueling of a fraction of the first subset at a time until fueling of all of the first subset has been inhibited;
determine a need to inhibit fueling of a second subset of the plurality of combustion chambers; and
selectively regulate the plurality of fuel injectors to inhibit fueling of all of the second subset and to substantially simultaneously begin fueling of all of the first subset,
wherein the number of combustion chambers included within the first subset is equal to the number of combustion chambers included within the second subset.
